(19) United States
(12) Patent Application Publication
(10) Pub. No.: US 2021/0256851 A1
(43) Pub. Date: Aug. 19, 2021

(54) INFORMATION PROCESSING APPARATUS, INFORMATION PROCESSING METHOD, AND RECORDING MEDIUM

(71) Applicant: TOYOTA JIDOSHA KABUSHIKI KAISHA, Toyota-shi (JP)

(72) Inventors: Naoki UENOYAMA, Nagoya-shi (JP); Takumi FUKUNAGA, Nisshin-shi (JP); Shin SAKURADA, Toyota-shi (JP); Hikaru GOTOH, Nagoya-shi (JP); Josuke YAMANE, Nisshin-shi (JP); Soutaro KANEKO, Nagoya-shi (JP); Rio MINAGAWA, Nagoya-shi (JP)

(73) Assignee: TOYOTA JIDOSHA KABUSHIKI KAISHA, Toyota-shi (JP)

(21) Appl. No.: 17/173,247

(22) Filed: Feb. 11, 2021

(30) Foreign Application Priority Data
Feb. 14, 2020 (JP) 2020-023508

(51) Int. Cl. G08G 1/16; B60W 60/00

(52) U.S. Cl. CPC G08G 1/167; B60W 60/0027; B60W 2552/10; B60W 2554/4049; B60W 2552/53; B60W 2554/4045

(57) ABSTRACT

A vehicle traveling on an acceleration lane is allowed to smoothly merge into a main lane. An information processing apparatus includes a controller is configured to: identify a second vehicle traveling on a main lane behind a cutting-in position at which a first vehicle traveling on an acceleration lane cuts in; and perform at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.

### CROSS REFERENCE TO RELATED APPLICATION

This application claims the benefit of Japanese Patent Application No. 2020-023508, filed on Feb. 14, 2020, which is hereby incorporated by reference herein in its entirety.

### BACKGROUND

### Technical Field

The present disclosure relates to an information processing apparatus, an information processing method, and a recording medium recorded with a program.

### Description of the Related Art

A driving support device has been disclosed that, when a vehicle enters an intersection, provides guidance so that collision with another vehicle approaching the intersection does not occur (for example, Patent document 1).

### CITATION LIST

### Patent Document

[Patent document 1] Japanese Patent Laid-Open No. 2009-245340

Another example of merging of vehicles is, for example, merging on an expressway, from an acceleration lane into a main lane. If vehicles traveling on the acceleration lane intend to merge into the main lane at respective arbitrary timings, a plurality of vehicles traveling on the main lane may be caused to decelerate, and such deceleration may be one of reasons for causing congestion or worsening congestion as a result. Similar problems may also occur on roads having merging points, as well as at merging points on expressways.

An object of one aspect of the disclosure is to provide an information processing apparatus, an information processing method, and a recording medium recorded with a program that allow a vehicle traveling on an acceleration lane to smoothly merge into a main lane.

### SUMMARY

One aspect of the present disclosure is an information processing apparatus, comprising a controller configured to:

identify a second vehicle traveling on a main lane behind a cutting-in position at which a first vehicle traveling on an acceleration lane cuts in; and perform at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.

Another aspect of the present disclosure is an information processing method, comprising:

identifying a second vehicle traveling on a main lane behind a cutting-in position at which a first vehicle traveling on an acceleration lane cuts in; and

performing at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.

Another aspect of the present disclosure is a non-transitory computer-readable recording medium recorded with a program causing a computer to execute:

identifying a second vehicle traveling on a main lane behind a cutting-in position at which a first vehicle traveling on an acceleration lane cuts in; and

at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.

According to the present disclosure, it is possible that a vehicle traveling on an acceleration lane is allowed to smoothly merge into a main lane.

### BRIEF DESCRIPTION OF DRAWINGS

FIG. 1 illustrates an example of a system configuration of a merging guidance system according to a first embodiment;

FIG. 2 illustrates an example of a hardware configuration of the road-side apparatus;

FIG. 3 illustrates an example of a hardware configuration of the vehicle;

FIG. 4 illustrates an example of functional configurations of the road-side apparatus and the vehicle;

FIG. 5 is an example of a flowchart of vehicle information acquisition processing by the road-side apparatus;

FIG. 6 is an example of a flowchart of merging guidance processing by the road-side apparatus;

FIG. 7 is an example of a flowchart of processing when a vehicle receives a merging point approach signal;

FIG. 8 is an example of a flowchart of processing when a vehicle receives guidance information;

FIG. 9 illustrates a specific example of the merging guidance processing;

FIG. 10 illustrates an example of a system configuration of a merging guidance system according to a second embodiment;

FIG. 11 illustrates an example of a functional configuration of a vehicle according to the second embodiment;

FIG. 12 is an example of processing when a vehicle passes through a merging point according to the second embodiment;

FIG. 13A is an example of a flowchart of merging guidance processing by the vehicle according to the second embodiment;

FIG. 13B is an example of a flowchart of merging guidance processing by the vehicle according to the second embodiment; and

FIG. 14 is an example of a flowchart of merging guidance processing by the vehicle according to the third embodiment.

### DESCRIPTION OF THE EMBODIMENTS

For example, on an expressway, it is recommended to merge into a main lane at a far end of an acceleration lane, in terms of reduction of congestion, avoidance of danger, and the like. A merging method in which vehicles traveling on the main lane and vehicles on the acceleration lane alternately merge in such a manner that one leading vehicle on the acceleration lane merges into the main lane to follow one vehicle traveling on the main lane, is also referred to as a zipper method. In the present disclosure, merging according to the zipper method is accomplished by providing guidance such that a vehicle traveling on an acceleration lane merges into a main lane at a far end of the acceleration lane.

Specifically, an aspect of the present disclosure is an information processing apparatus including a controller. The controller is configured to: identify a second vehicle traveling on a main lane behind a cutting-in position at which a first vehicle traveling on an acceleration lane cuts in; and perform at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.

The information processing apparatus may be, for example, a road-side apparatus installed in a vicinity of a merging point of the acceleration lane and the main lane, or may be an in-vehicle apparatus mounded in a vehicle corresponding to the first vehicle. The information processing apparatus may be a server. The controller is, for example, a processor such as a CPU (Control Processing Unit) or a DSP (Digital Signal Processor) included in such apparatuses. Prompting the second vehicle to assist the first vehicle in merging into the main lane means, for example, advising to allow the first vehicle to merge in front of the second vehicle.

According to the aspect of the present disclosure, the first vehicle traveling on the acceleration lane is provided with the guidance that prompts the first vehicle to merge at the far end of the acceleration lane, and the second vehicle traveling on the main lane is provided with the guidance that prompts the second vehicle to assist the first vehicle in merging into the main lane. Since guidance is provided to both the first vehicle on a merging side and the second vehicle on an allowing merging side as described above, it is highly probable that merging of the first vehicle into the main lane is performed more smoothly.

In the aspect of the present disclosure, the controller may be configured to further perform identifying a third vehicle traveling on the main lane ahead of the cutting-in position. In such a case, the controller may be configured to notify the first vehicle, as the first guidance, to merge into the main lane immediately behind the third vehicle, and of information related to an external appearance of the third vehicle. Further, the controller may be configured to notify the first vehicle, as the first guidance, to merge into the main lane in front of the second vehicle, and of information related to an external appearance of the second vehicle. The controller may be configured to notify the second vehicle, as the second guidance, to allow the first vehicle to merge into the main lane in front of the second vehicle, and of information related to an external appearance of the first vehicle.

By notifying the first vehicle to merge into the main lane immediately behind the third vehicle, a driver of the first vehicle can easily time merging, knowing which vehicle to follow on the main lane. By notifying the first vehicle of the information related to the external appearance of the third vehicle, the driver of the first vehicle can easily identify the third vehicle. By notifying the first vehicle of the information related to the second vehicle traveling behind the cutting-in position on the main lane, the driver of the first vehicle can easily time merging, knowing where to merge on the main lane. By notifying the second vehicle of the information related to the first vehicle to be allowed to merge into the main lane in front of the second vehicle, a driver of the second vehicle can assist the first vehicle in merging into the main lane, and the first vehicle can merge into the main lane more smoothly.

In the aspect of the present disclosure, the controller may be configured to notify the first guidance when it is detected that the first vehicle enters a merging area including the far end of the acceleration lane. Thus, the first vehicle can be prompted to perform merging at the far end of the acceleration lane.

In the aspect of the present disclosure, the controller may be configured to notify the first guidance when the first vehicle travels at a front on the acceleration lane. Thus, the first vehicle can be prompted to perform merging at the front of vehicles traveling on the acceleration lane.

In the aspect of the present disclosure, the controller may be further configured to notify the first vehicle of third guidance that indicates to wait for merging into the main lane when the first vehicle travels on the acceleration lane short of the merging area. Thus, the first vehicle can be restrained from merging into the main lane before reaching the merging area.

In the following, an embodiment of the present disclosure will be described with reference to the drawings. The configuration of the embodiment described below is an example, and the present disclosure is not limited to the configuration of the embodiment.

### First Embodiment

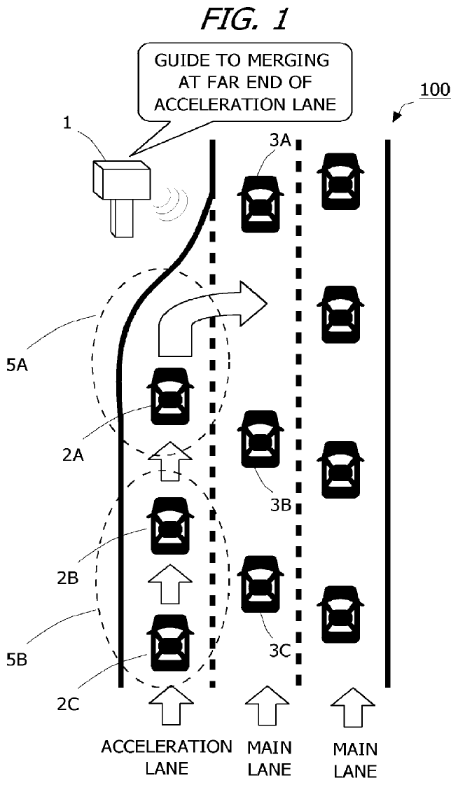

FIG. 1 illustrates an example of a system configuration of a merging guidance system 100 according to a first embodiment. The merging guidance system 100 is a system that guides a vehicle, for example, such that merging on an expressway from an interchange to a main lane is performed at a far end of an acceleration lane. The merging guidance system 100 includes, for example, a road-side apparatus 1. The road-side apparatus 1 includes, for example, a camera, and, by analyzing an image picked up by the camera, identifies a vehicle 2A on the acceleration lane that intends to merge into the main lane and a vehicle 3B that allows the vehicle 2A to come in front on the main lane, and provides guidance about merging to both the vehicles. The road-side apparatus 1 and the vehicles are capable of, for example, road-to-vehicle communication, and the guidance is notified through the communication.

First, merging according to the zipper method is as follows. For example, vehicles traveling on an acceleration lane merge into a main lane at a far end of the acceleration lane, in turns from a leading vehicle. Further, when the leading vehicle has merged into the main lane, a subsequent vehicle on the acceleration lane next merges into the main lane after allowing one vehicle on the main lane to pass. For example, in the example illustrated in FIG. 1, the vehicle 2A merges into the main lane by cutting in between a vehicle 3A and the vehicle 3B on the main lane. After the vehicle 2A merges into the main lane, a vehicle 2B advances to the far end of the acceleration lane and merges into the main lane by cutting in between the vehicle 3B and a vehicle 3C. The road-side apparatus 1 guides each vehicle such that merging is performed according to such a zipper method. Hereinafter, when vehicles on the acceleration lane and the main lane are comprehensively treated without differentiation, such a vehicle will be referred to as vehicle 2.

In the first embodiment, the road-side apparatus 1 issues a merging point approach signal including information indicating a vicinity of a merging point, in each predetermined period. The merging point approach signal is issued, for example, in a multicast or broadcast. The merging point approach signal may be a beacon. The merging point approach signal includes, for example, identification information on the road-side apparatus 1. The identification information on the road-side apparatus 1 included in the merging point approach signal is, for example, an address of the road-side apparatus 1 used in road-to-vehicle communication.

When a vehicle 2 receives the merging point approach signal from the road-side apparatus 1, the vehicle 2 transmits vehicle information related to the vehicle 2 to the road-side apparatus 1. The vehicle information includes, for example, identification information on the vehicle 2 and information related to an external appearance of the vehicle 2. For example, the identification information on the vehicle 2 may be, but is not limited to, an address used in road-to-vehicle communication and vehicle-to-vehicle communication. The information related to the external appearance of the vehicle 2 includes, for example, vehicle identification information stated on a license plate, a vehicle type, a vehicle body color, and the like.

On a road, a predetermined range 5A including the far end of the acceleration lane is set as a merging area. A predetermined range 5B on the acceleration lane short of the merging area is set as a waiting-for-merging area.

The road-side apparatus 1 includes the camera that includes, in an image-pickup range, the merging area 5A, the waiting-for-merging area 5B, and a predetermined range on the main lane adjacent to the merging area 5A and the waiting-for-merging area 5B. It is assumed that the image-pickup range of the camera is fixed. The road-side apparatus 1 performs image recognition processing on an image picked up by the camera, and identifies a positional relationship between each vehicle 2. The identification of each vehicle 2 is performed, for example, based on the information related to the vehicle external appearance received from each vehicle 2. By identifying the positional relationship between each vehicle 2, for example, the leading vehicle 2A in the merging area 5A, the vehicle 2B and a vehicle 2C in the waiting-for-merging area 5B, and the vehicle 3A and the vehicle 3B between which the leading vehicle 2A is to cut in can be identified. Hereinafter, of vehicles on the main lane between which a vehicle on the acceleration lane is to cut in, the vehicle to precede the leading vehicle will be referred to as preceding vehicle, and the vehicle to follow the leading vehicle will be referred to as following vehicle. In other words, in the example illustrated in FIG. 1, with respect to the vehicle 2A, the preceding vehicle is the vehicle 3A, and the following vehicle is the vehicle 3B. The preceding vehicle is an example of the “third vehicle”. The following vehicle is an example of the “second vehicle”.

The road-side apparatus 1 transmits, to the leading vehicle 2A in the merging area 5A, merging guidance information indicating to merge into the main lane at the far end of the acceleration lane. The merging guidance information may also include, for example, information that the preceding vehicle is the vehicle 3A, and information related to an external appearance of the preceding vehicle 3A. The road-side apparatus 1 transmits, to the following vehicle 3B, merging assist guidance information indicating to allow a vehicle on the acceleration lane to merge into the main lane. The merging assist guidance information may also include, for example, information that the vehicle to be allowed to merge is the vehicle 2A, and information related to an external appearance of the vehicle 2A. In the first embodiment, the road-side apparatus 1 transmits, to the vehicle 2B and the vehicle 2C located in the waiting-for-merging area 5B, waiting-for-merging guidance information indicating to wait for merging into the main lane. The merging guidance information is an example of the “first guidance”. The merging assist guidance information is an example of the “second guidance”. The waiting-for-merging guidance information is an example of “third guidance”.

A driver of each vehicle 2 performs driving in accordance with the guidance information from the road-side apparatus 1, whereby merging according to the zipper method can be accomplished, for example, during congestion.

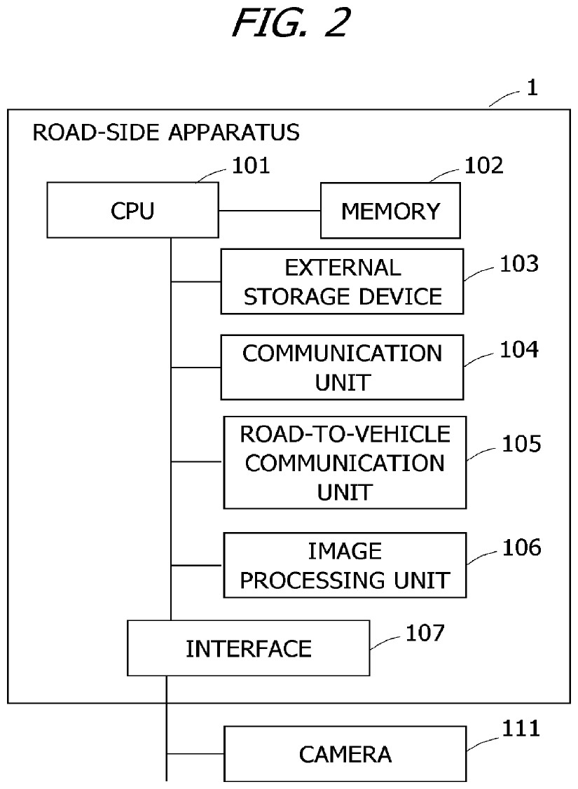

FIG. 2 illustrates an example of a hardware configuration of the road-side apparatus 1. The road-side apparatus 1 includes, as hardware components, a CPU 101, a memory 102, an external storage device 103, a communication unit 104, a road-to-vehicle communication unit 105, an image processing unit 106, and an interface 107. The road-side apparatus 1 is connected to a camera 111 via the interface 107. The memory 102 and the external storage device 103 are computer-readable recording media. The road-side apparatus 1 is an example of the “information processing apparatus”.

The external storage device 103 stores various programs, and data used by the CPU 101 when each program is executed. The external storage device 103 is, for example, an EPROM (Erasable Programmable ROM) and/or an HDD (Hard Disk Drive). The programs retained in the external storage device 103 include, for example, an operating system (OS), a merging guidance control program, and other various application programs. The merging guidance control program is a program for performing guidance control of vehicles 2 in the vicinity of the merging point such that a leading vehicle is allowed to merge into the main lane at the far end of the acceleration lane.

The memory 102 is a main memory that provides the CPU 101 with a storage area and a work area where a program stored in the external storage device 103 is loaded, and that is used for a buffer. The memory 102 includes, for example, a ROM (Read Only Memory) and a semiconductor memory such as a RAM (Random Access Memory).

The CPU 101 executes various processing by loading and executing the OS and the various application programs retained in the external storage device 103 on the memory 102. The number of CPUs 101 is not limited to one, and a plurality of CPUs 101 may be included. The CPU 101 is an example of the “controller” of the “information processing apparatus”.

The communication unit 104 is an interface that receives information as input from and outputs information to a network. For example, the communication unit 104 is connected to a wired or wireless network and, through the network, connected to a public line network such as the Internet. The wired network to which the communication unit 104 is connected is, for example, a LAN (Local Area Network) or an access network to the Internet provided by a telecommunication carrier. The wireless network to which the communication unit 104 is connected is, for example, of mobile communication schemes such as LTE (Long Term Evolution), LTE-Advanced, and 5G (5th Generation), or of Wi-Fi.

The road-to-vehicle communication unit 105 communicates with the vehicles 2. For road-to-vehicle communication, for example, DSRC (Dedicated Short Range Communications) is used. Note that a communication system applied for the road-to-vehicle communication is not limited to DSRC.

The image processing unit 106 is, for example, an image recognition engine that performs image processing on an image picked up at a predetermined rate by the camera 111. For example, the image processing unit 106 detects a preset target object from the image. In the first embodiment, for example, a vehicle 2 is set as a detection target. Note that for a method for the image recognition processing performed by the image processing unit 106, any of existing methods may be used. A result of image recognition by the image processing unit 106 is outputted to the CPU 101.

The interface 107 connects a hardware component outside the road-side apparatus 1 to the road-side apparatus 1. For example, the camera 111 is connected to the interface 107. An angle of view of the camera 111 is set, for example, such that the merging area 5A, the waiting-for-merging area 5B, and the main lane adjacent to the merging area 5A and the waiting-for-merging area 5B are included in the image-pickup range. The camera 111 picks up an image at the predetermined rate, and the picked-up image is outputted to the image processing unit 106. Note that the hardware configuration of the road-side apparatus 1 illustrated in FIG. 2 is an example, and such an example does not constitute a limitation.

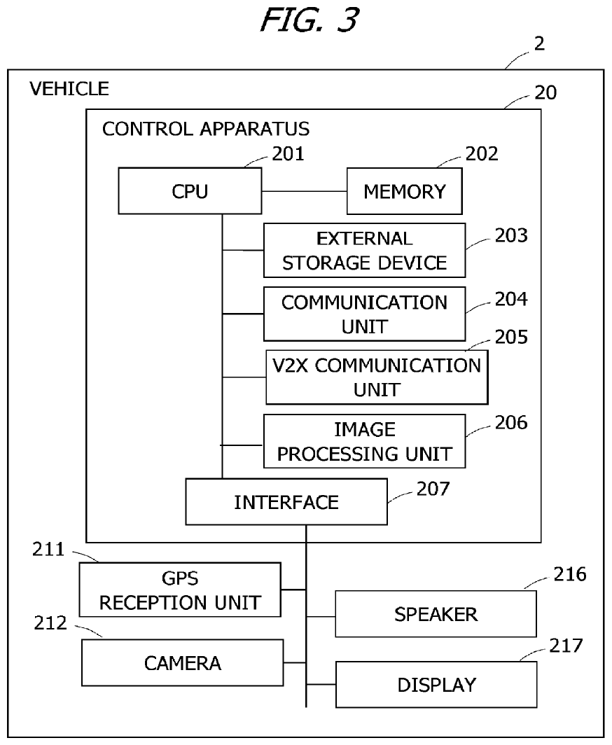

FIG. 3 illustrates an example of a hardware configuration of the vehicle 2. The vehicle 2 is, for example, an automobile that travels by being driven by a driver. Note that in FIG. 3, among hardware components of the vehicle 2, hardware components related to processing described in the first embodiment are extracted and illustrated. The vehicle 2 includes, as hardware components, a control apparatus 20, a GPS reception unit 211, a camera 212, a speaker 216, and a display 217.

The GPS reception unit 211 receives radio waves of time signals from a plurality of artificial satellites (Global Positioning Satellites) orbiting the earth, and makes output to, for example, the control apparatus 20. Based on the signals detected by the GPS reception unit 211, for example, a latitude and a longitude that represent a position on the earth are acquired as position information.

The camera 212 is, for example, a camera installed toward an outside of the vehicle 2, with a predetermined direction as an image picking-up direction. A plurality of cameras 212 may be included in the vehicle 2. For example, the cameras 212 may include one whose image picking-up direction is a front outside of the vehicle 2, one whose image picking-up direction is a rear outside of the vehicle 2, one whose image picking-up direction is a right outside of the vehicle 2, and one whose image picking-up direction is a left outside of the vehicle 2. For the camera 212, for example, a camera used in another apparatus such as a dashboard camera may be concurrently used, or the camera 212 may be provided dedicatedly for the processing related to the first embodiment.

The speaker 216 is an audio output device installed toward an inside of the vehicle 2. The speaker 216 outputs, as voice or sound, audio data inputted from the control apparatus 20. The display 217 is installed toward the inside of the vehicle 2. The display 217 outputs image data and moving image data inputted from the control apparatus 20. For the speaker 216 and the display 217, for example, a speaker and a display used in another apparatus such as a car navigation system may be concurrently used, or the speaker 216 and the display 217 may be provided dedicatedly for the processing related to the first embodiment.

For example, the control apparatus 20 may be, but is not limited to, a data communication apparatus or an ECU. The control apparatus 20 includes, as hardware components, a CPU 201, a memory 202, an external storage device 203, a communication unit 204, a V2X (Vehicle to X) communication unit 205, an image processing unit 206, and an interface 207. The memory 202 and the external storage device 203 are computer-readable recording media.

The CPU 201, the memory 202, the external storage device 203, and the image processing unit 206 are like the CPU 101, the memory 102, the external storage device 103, and the image processing unit 106 of the road-side apparatus 1, respectively. The communication unit 204 is an interface that receives information as input from and outputs information to the network. The communication unit 204 connects to a public line network such as the Internet, for example, by performing communication based on any of mobile communication schemes such as LTE, LTE-Advanced, and 5G, or Wi-Fi communication.

The V2X communication unit 205 performs vehicle-to-vehicle communication with another vehicle and road-to-vehicle communication with the road-side apparatus 1. For the vehicle-to-vehicle communication and the road-to-vehicle communication performed by the V2X communication unit 205, for example, DSRC is used.

The interface 207 connects a hardware component within the vehicle 2 outside the control apparatus 20 to the control apparatus 20. The GPS reception unit 211, the camera 212, the speaker 216, the display 217, and the like are connected to the interface 207. Note that the hardware configuration of the vehicle 2 illustrated in FIG. 3 is an example, and such an example does not constitute a limitation.

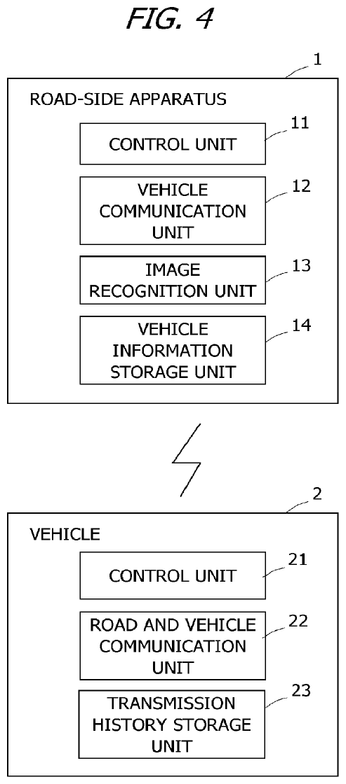

FIG. 4 illustrates an example of functional configurations of the road-side apparatus 1 and the vehicle 2. The vehicle 2 includes, as functional components, a control unit 21, a road and vehicle communication unit 22, and a transmission history storage unit 23. The functional components are implemented in such a manner that the CPU 201 of the vehicle 2 executes a predetermined program.

The road and vehicle communication unit 22 is an interface when communication is performed with the road-side apparatus 1 and another vehicle 2 via the V2X communication unit 205. The road and vehicle communication unit 22 receives, for example, a merging point approach signal issued in each predetermined period and guidance information related to merging from the road-side apparatus 1. The road and vehicle communication unit 22 outputs data received from the road-side apparatus 1 to the control unit 21. The road and vehicle communication unit 22 transmits, for example, vehicle information inputted from the control unit 21 to the road-side apparatus 1. Note that in the first embodiment, communication between vehicles 2 does not occur.

The control unit 21 controls processing related to merging guidance on a vehicle 2 side. When a merging point approach signal received from the road-side apparatus 1 is inputted from the road and vehicle communication unit 22, the control unit 21 transmits the vehicle information on the vehicle 2 to the road-side apparatus 1 via the road and vehicle communication unit 22. The vehicle information includes, for example, the identification information on the vehicle 2, and information related to an external appearance of the vehicle 2. The vehicle information is transmitted, for example, in a unicast. The control unit 21 registers history information on transmission of the vehicle information to the road-side apparatus 1 in the transmission history storage unit 23. The history information includes, for example, information related to a destination and a time of transmission.

While the history information on transmission of the vehicle information to the road-side apparatus 1 is stored in the transmission history storage unit 23, the control unit 21 does not transmit the vehicle information to the road-side apparatus 1 of interest even when a merging point approach signal is received from the road-side apparatus 1 of interest. When a condition for deletion of a transmission history is satisfied, the control unit 21 deletes, from the transmission history storage unit 23, the history information on transmission of the vehicle information to the road-side apparatus 1 of interest. The condition for deletion of a transmission history is any one or more of a fact that a predetermined time period has passed since the vehicle information was transmitted to the road-side apparatus 1 of interest, a fact that a merging point approach signal is not received from the road-side apparatus 1 of interest, a fact that there is a predetermined distance or more from the road-side apparatus 1 of interest, and the like. In a case where a plurality of conditions for deletion of a transmission history are set, the history information on transmission of the vehicle information to the road-side apparatus 1 of interest may be deleted from the transmission history storage unit 23 when any one condition is satisfied.

When guidance information received from the road-side apparatus 1 is inputted from the road and vehicle communication unit 22, the control unit 21 causes the speaker 216 or/and the display 217 to output the guidance information. It is determined depending on a data format of the guidance information, from which of the speaker 216 and the display 217 the guidance information is outputted.

The transmission history storage unit 23 stores history information on transmission of the vehicle information. The transmission history storage unit 23 is created, for example, in the storage area of the memory 202. The history information on transmission of the vehicle information stored in the transmission history storage unit 23 includes, for example, information on a destination of the vehicle information and a time of transmission. The history information on transmission of the vehicle information stored in the transmission history storage unit 23 is registered and deleted, for example, by the control unit 21 as described above.

Next, the road-side apparatus 1 includes, as functional components, a control unit 11, a vehicle communication unit 12, an image recognition unit 13, and a vehicle information storage unit 14. The functional components are implemented in such a manner that the CPU 101 of the road-side apparatus 1 executes a predetermined program.

The vehicle communication unit 12 is an interface when communication is performed with a vehicle 2 via the road-to-vehicle communication unit 105. For example, the vehicle communication unit 12 receives vehicle information from a vehicle 2. For example, the vehicle communication unit 12 receives a merging point approach signal as input from the control unit 11 in each predetermined period and transmits the merging point approach signal in a multicast or broadcast. For example, the vehicle communication unit 12 receives guidance information as input from the control unit 11 and transmits the guidance information to a designated vehicle 2.

The control unit 11 controls processing related to merging guidance on a road-side apparatus 1 side. For example, when a section on the road including the merging point monitored by the road-side apparatus 1 is congested, the control unit 11 transmits a merging point approach signal in a multicast or broadcast in each predetermined period. The merging point approach signal is transmitted via the vehicle communication unit 12. The merging point approach signal includes, for example, the identification information on the road-side apparatus 1. The fact that the section on the road including the merging point monitored by the road-side apparatus 1 is congested may be acquired, for example, from a server that manages traffic congestion information, or by acquiring information issued by VICS (Vehicle Information and Communication System: registered trademark), via the communication unit 104.

When vehicle information received from a vehicle 2 is inputted from the road-to-vehicle communication unit 105, the control unit 11 stores the vehicle information in the vehicle information storage unit 14, which will be described later. The control unit 11 instructs the image recognition unit 13 to start image recognition processing for the vehicle 2 corresponding to the received vehicle information.

The control unit 11 receives a result of recognition of vehicle in an image picked up by the camera 111, as input, at a predetermined rate from the image recognition unit 13. The result of recognition of vehicle in the image picked up by the camera 111 includes, for example, vehicles 2 detected in the picked-up image, and position information on each vehicle 2. The position information on each vehicle 2 detected from the picked-up image includes, for example, information about a lane (the acceleration lane or the main lane) on which the vehicle 2 is located, whether the vehicle 2 is located in the merging area or the waiting-for-merging area, vehicles 2 located in front of, behind, to the right of, and to the left of the vehicle 2, and the like.

From the result of recognition of vehicle in the image picked up by the camera 111, the control unit 11 identifies, for example, vehicles 2 in the merging area, vehicles 2 in the waiting-for-merging area, and a preceding vehicle and a following vehicle on the main lane for each vehicle 2 in the merging area. For example, in the example illustrated in FIG. 1, for the leading vehicle 2A in the merging area, the following vehicle 3B to follow the vehicle 2A, and the vehicles 2B and 2C in the waiting-for-merging area, the control unit 11 generates guidance information and the like according to each of the vehicles and transmits the guidance information via the vehicle communication unit 12, respectively.

The control unit 11 transmits, to the leading vehicle 2A in the merging area, for example, merging guidance information indicating to merge into the main lane at the far end of the acceleration lane. The merging guidance information includes, for example, the information that the preceding vehicle is the vehicle 3A, and the information related to the external appearance of the preceding vehicle 3A to precede the vehicle 2A. In actuality, the merging guidance information is a message including the above-described information. Specifically, the message as the merging guidance information may be, but is not limited to, “Please merge at the far end of the lane, to follow <vehicle type> in <vehicle body color>” or the like. For example, the message as the merging guidance information may be “Please merge at the far end of the lane, to follow a vehicle ahead on the main lane” or the like, which does not include the information that the preceding vehicle is the vehicle 3A, or the information related to the external appearance of the preceding vehicle 3A to precede the vehicle 2A.

The control unit 11 transmits, to the following vehicle 3B, merging assist guidance information indicating to allow a vehicle on the acceleration lane to merge into the main lane. The merging assist guidance information includes, for example, the information that the vehicle to be allowed to merge is the vehicle 2A, and the information related to the external appearance of the vehicle 2A. In actuality, the merging assist guidance information is a message including the above-described information. Specifically, the message as the merging assist guidance information may be, but is not limited to, “Please allow <vehicle type> in <vehicle body color> to merge” or the like. For example, the message as the merging assist guidance information may be “Please allow the leading vehicle on the acceleration lane to merge” or the like, which does not include the information that the vehicle to be allowed to merge is the vehicle 2A, or the information related to the external appearance of the vehicle 2A.

The control unit 11 transmits, to the vehicle 2B and the vehicle 2C located in the waiting-for-merging area 5B, waiting-for-merging guidance information indicating to wait for merging into the main lane. In actuality, the waiting-for-merging guidance information is a message including the above-described information. Specifically, the message as the waiting-for-merging guidance information may be, but is not limited to, “Please refrain from merging at the present position” or the like.

The control unit 11 deletes from the vehicle information storage unit 14, for example, the vehicle information related to a vehicle 2 that becomes not recognized from an image picked up by the camera 111. Note that a timing of deleting the vehicle information from the vehicle information storage unit 14 is not limited to such a timing.

The image recognition unit 13 corresponds to, for example, the image processing unit 106. For example, the image recognition unit 13 detects, from an image picked up by the camera 111, a vehicle 2 that matches vehicle information inputted from the control unit 11 and acquires position information on the detected vehicle 2. The image recognition unit 13 outputs identification information and the position information on the detected vehicle 2 as a result of recognition to the control unit 11.

The vehicle information storage unit 14 stores vehicle information received from a vehicle 2. The vehicle information storage unit 14 is created, for example, in the storage area of the memory 102. The vehicle information stored in the vehicle information storage unit 14 is registered and deleted by the control unit 11 as described above. In the vehicle information storage unit 14, a fact that guidance is provided to the corresponding vehicle, and a type of the guidance may also be recorded along with the vehicle information.

Note that the functional components of the road-side apparatus 1 and the vehicle 2 are an example, and are not limited to the example illustrated in FIG. 4. Processing performed by each functional component of the road-side apparatus 1 and the vehicle 2 may be accomplished, for example, by hardware such as an FPGA (Field-Programmable Gate Array).

<Flow of Processing>

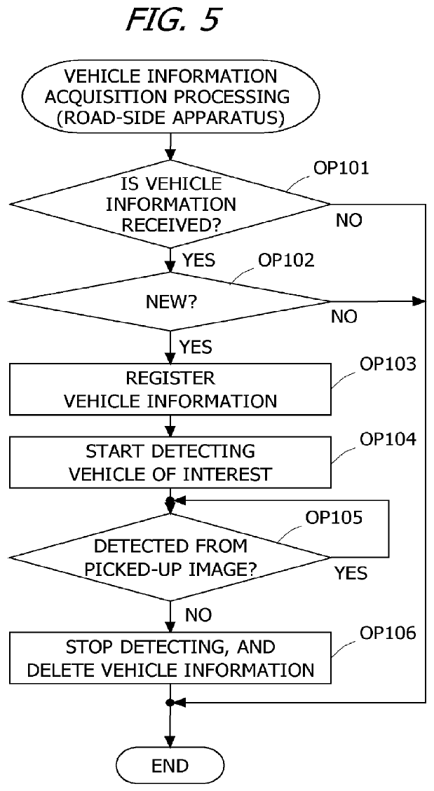

FIG. 5 is an example of a flowchart of vehicle information acquisition processing by the road-side apparatus 1. For example, the processing illustrated in FIG. 5 is performed repeatedly while occurrence of congestion is detected in the section on the road including the merging point covered by the road-side apparatus 1. Note that periodical transmission of a merging point approach signal is also started together with the vehicle information acquisition processing illustrated in FIG. 5. Although an entity that executes the processing illustrated in FIG. 5 is the CPU 101, a description will be given by using a functional component as an executing entity for convenience. The same is true to flowcharts described below.

In OP101, the control unit 11 determines whether or not vehicle information is received from any vehicle 2. When vehicle information is received (OP101: YES), the processing advances to OP102. When vehicle information is not received (OP101: NO), the processing illustrated in FIG. 5 is terminated.

In OP102, the control unit 11 determines whether or not the received vehicle information is new. The processing in OP102 is performed, for example, by determining whether or not the same information as the received vehicle information is already stored in the vehicle information storage unit 14. When the received vehicle information is new (OP102: YES), the processing advances to OP103. When the received vehicle information is not new (OP102: NO), the processing illustrated in FIG. 5 is terminated.

In OP103, the control unit 11 stores the received vehicle information in the vehicle information storage unit 14. In OP104, the control unit 11 instructs the image recognition unit 13 to start detecting the vehicle 2 corresponding to the received vehicle information.

In OP105, the control unit 11 determines whether or not the vehicle 2 is detected from an image picked up by the camera 111. When the vehicle 2 is detected from an image picked up by the camera 111 (OP105: YES), the processing in OP105 is repeated. When the vehicle 2 is not detected from an image picked up by the camera 111 (OP105: NO), the processing advances to OP106.

In OP106, the control unit 11 instructs the image recognition unit 13 to stop detecting the vehicle 2, and deletes the vehicle information on the vehicle 2 from the vehicle information storage unit 14. Thus, for example, when the vehicle 2 exits by traveling from the image-pickup range of the camera 111, detection of the vehicle 2 from an image picked up by the camera 111 is stopped. Thereafter, the processing illustrated in FIG. 5 is terminated.

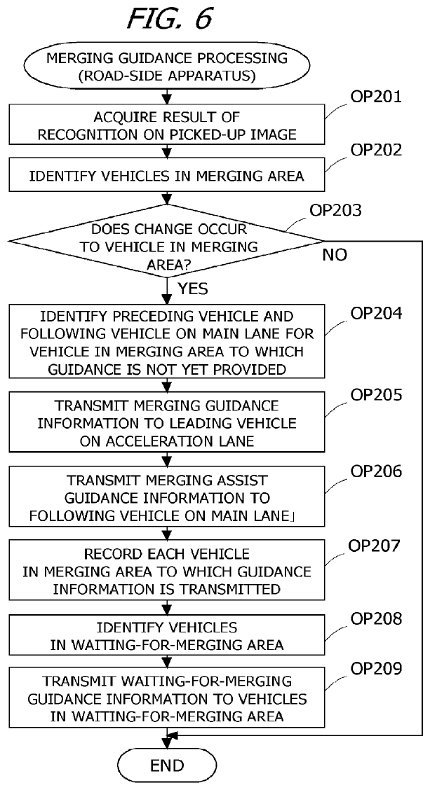

FIG. 6 is an example of a flowchart of merging guidance processing by the road-side apparatus 1. For example, the processing illustrated in FIG. 6 is performed repeatedly in each predetermined period while occurrence of congestion is detected in the section on the road including the merging point covered by the road-side apparatus 1. For example, the processing illustrated in FIG. 6 may be performed in accordance with the frame rate of the camera 111.

In OP201, the control unit 11 acquires a result of recognition processing on an image picked up by the camera 111 from the image recognition unit 13. The control unit 11 buffers the acquired result of recognition on the picked-up image. In OP202, the control unit 11 identifies a vehicle 2 existing in the merging area 5A from the result of recognition on the picked-up image.

In OP203, the control unit 11 compares the result of recognition on the picked-up image acquired in OP201 with a result of recognition on a picked-up image acquired when latest previous processing was performed, and determines whether or not a change occurs to the vehicle 2 in the merging area. Changes to the vehicle 2 in the merging area include, for example, addition of a new vehicle 2, a change of the leading vehicle, and the like. When a change occurs to the vehicle 2 in the merging area (OP203: YES), the processing advances to OP204. When a change does not occur to the vehicle 2 in the merging area (OP203: NO), the processing illustrated in FIG. 6 is terminated.

In OP204, with respect to the vehicle 2 in the merging area to which guidance is not yet provided, the control unit 11 identifies a preceding vehicle and a following vehicle for the vehicle 2, from the result of recognition on the picked-up image. The control unit 11 stores the identified preceding vehicle and following vehicle, for example, in the vehicle information storage unit 14, in association with vehicle information on the vehicle 2 of interest. The vehicle 2 to which guidance is not yet provided is a vehicle 2 to which merging guidance information is not yet transmitted, and it is recorded, for example, in the vehicle information storage unit 14 whether or not merging guidance information is already transmitted.

In OP205, the control unit 11 transmits merging guidance information to the leading vehicle on the acceleration lane. In OP206, the control unit 11 transmits merging assist guidance information to the following vehicle on the main lane to follow the leading vehicle on the acceleration lane. In OP207, the control unit 11 records in the vehicle information storage unit 14 that the guidance information is transmitted to each vehicle in OP205 and OP206.

In OP208, the control unit 11 identifies a vehicle 2 in the waiting-for-merging area, from the result of recognition on the picked-up image. In OP209, the control unit 11 transmits waiting-for-merging guidance information to the vehicle 2 in the waiting-for-merging area. Thereafter, the processing illustrated in FIG. 6 is terminated.

In the processing illustrated in FIG. 6, owing to the processing in OP203, OP207, and the like, duplicative transmission of the same guidance information to the same vehicle 2 is restrained. This is because a driver of a vehicle 2 feels annoyed if the same guidance is repeatedly provided many times. Increases in a processing load on the road-side apparatus 1 and in a network load can be also restrained.

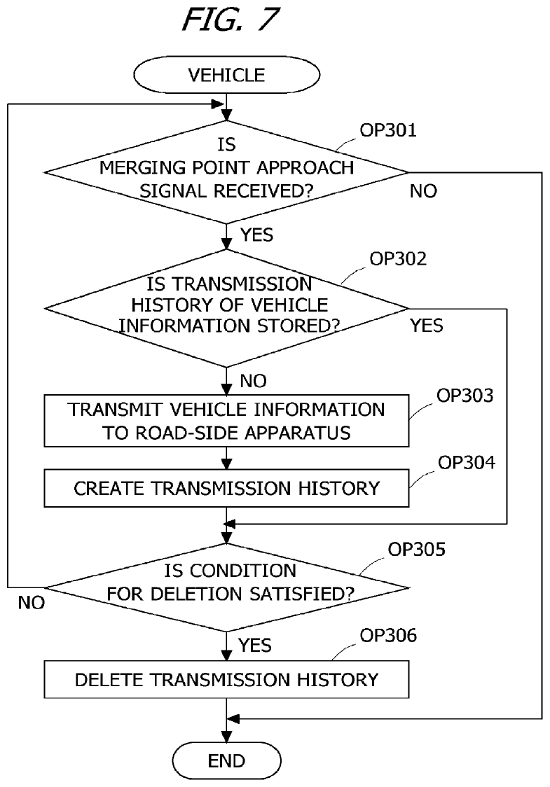

FIG. 7 is an example of a flowchart of processing when a vehicle 2 receives a merging point approach signal. The processing illustrated in FIG. 7 may be performed repeatedly, for example, while the control apparatus 20 of the vehicle 2 is in operation, or may be performed repeatedly, for example, while information that congestion is occurring on a traveled road is acquired via a car navigation system.

In OP301, the control unit 21 determines whether or not a merging point approach signal is received via the road and vehicle communication unit 22. When a merging point approach signal is received (OP301: YES), the processing advances to OP302. When a merging point approach signal is not received (OP301: NO), the processing illustrated in FIG. 7 is terminated.

In OP302, the control unit 21 determines whether or not there is a transmission history of the vehicle information to the road-side apparatus 1 that is a source of the merging point approach signal. The processing in OP302 is performed by determining whether or not identification information on the road-side apparatus 1 is stored as a destination of the vehicle information in the transmission history storage unit 23. When there is a transmission history of the vehicle information to the road-side apparatus 1 (OP302: YES), the processing advances to OP305. When there is not a transmission history of the vehicle information to the road-side apparatus 1 (OP302: NO), the processing advances to OP303.

In OP303, the control unit 21 transmits the vehicle information to the road-side apparatus 1 that is the source of the merging point approach signal. In OP304, the control unit 21 stores the identification information on the road-side apparatus 1 and a time of transmission of the vehicle information, as history information on transmission of the vehicle information, in the transmission history storage unit 23.

In OP305, the control unit 21 determines whether or not a condition for deletion of the transmission history is satisfied. The condition for deletion of the transmission history is any one or more of a fact that a predetermined time period has passed since the vehicle information was transmitted to the road-side apparatus 1, a fact that a merging point approach signal is not received from the road-side apparatus 1, a fact that there is a predetermined distance or more from the road-side apparatus 1, and the like. When the condition for deletion of the transmission history is satisfied (OP305: YES), the processing advances to OP306.

In OP306, the control unit 21 deletes the applicable history information on transmission of the vehicle information to the road-side apparatus 1 from the transmission history storage unit 23. Thereafter, the processing illustrated in FIG. 7 is terminated. By retaining a transmission history of the vehicle information, even when a merging point approach signal is received multiple times from the same road-side apparatus 1, the vehicle information is transmitted to the road-side apparatus 1 when the merging point approach signal is received for the first time. Thus, increases in processing loads on the vehicle 2 and the road-side apparatus 1, and use of a network band can be restrained.

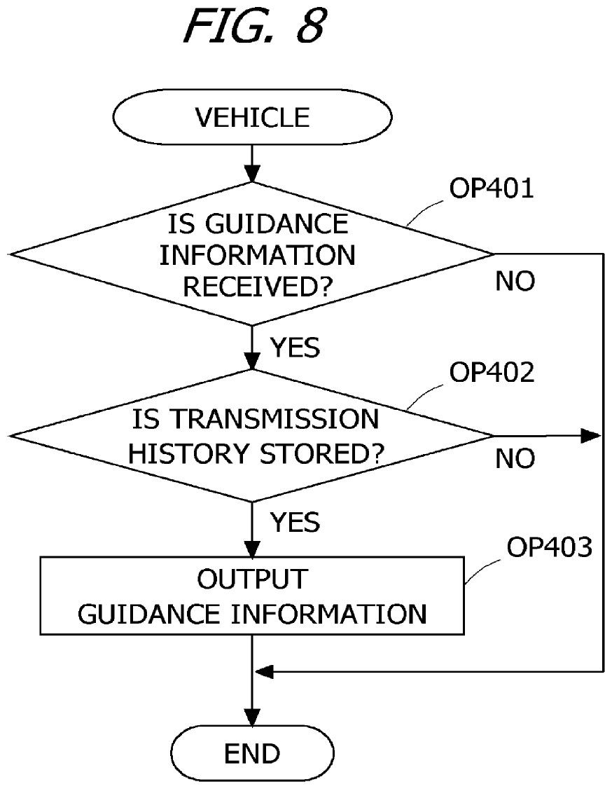

FIG. 8 is an example of a flowchart of processing when a vehicle 2 receives guidance information. For example, the processing illustrated in FIG. 8 is performed repeatedly while the control apparatus 20 of the vehicle 2 is in operation, or after a merging point approach signal is received until a merging point approach signal is not received.

In OP401, the control unit 21 determines whether or not guidance information is received. When guidance information is received (OP401: YES), the processing advances to OP402. When guidance information is not received (OP401: NO), the processing illustrated in FIG. 8 is terminated.

In OP402, the control unit 21 determines whether or not history information on transmission of the vehicle information to the road-side apparatus 1 that is a source of the guidance information is stored in the transmission history storage unit 23. When there is a transmission history of the vehicle information to the road-side apparatus 1 (OP402: YES), the processing advances to OP403. When there is not a transmission history of the vehicle information to the road-side apparatus 1 (OP402: NO), the processing illustrated in FIG. 8 is terminated.

In OP403, the control unit 21 outputs the received guidance information to the speaker 216 or/and the display 217. Thereafter, the processing illustrated in FIG. 8 is terminated.

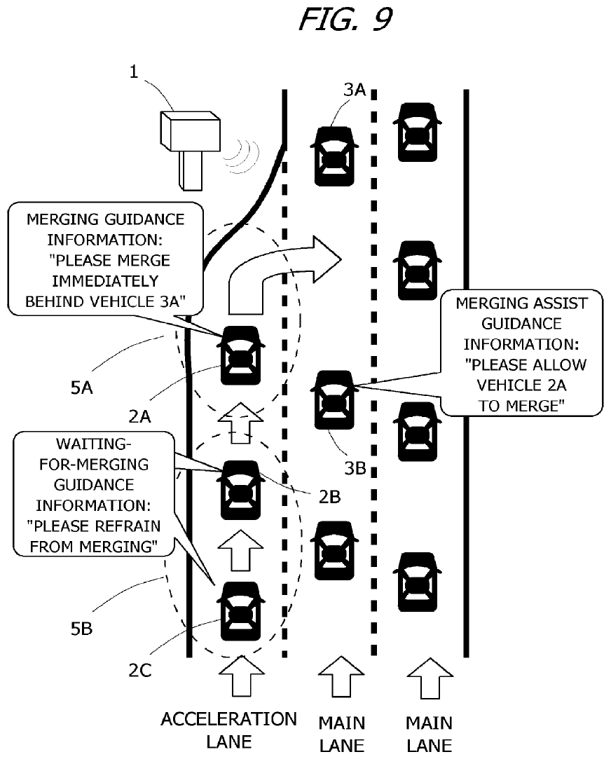

FIG. 9 illustrates a specific example of the merging guidance processing. It is assumed that a range over a road illustrated in FIG. 9 is within a reachable range of a merging point approach signal issued by the road-side apparatus 1. Accordingly, it is assumed that each vehicle in the example illustrated in FIG. 9 receives a merging point approach signal from the road-side apparatus 1, and has already transmitted the vehicle information to the road-side apparatus 1. It is assumed that the road-side apparatus 1 has already retained the vehicle information on each vehicle in the example illustrated in FIG. 9.

The image-pickup range of the camera 111 of the road-side apparatus 1 includes the merging area 5A, the waiting-for-merging area 5B, and the predetermined range on the main lane adjacent to the merging area 5A and the waiting-for-merging area 5B. The road-side apparatus 1 detects from an image picked up by the camera 111 that the vehicle 2A is located in the merging area 5A (FIG. 6, OP202). The road-side apparatus 1 identifies a space between the vehicle 3A and the vehicle 3B as a cutting-in position at which the vehicle 2A cuts in on the main lane. In other words, the road-side apparatus 1 identifies the vehicle 3A as a preceding vehicle and the vehicle 3B as a following vehicle, for the vehicle 2A (FIG. 6, OP204).

The road-side apparatus 1 transmits, to the vehicle 2A, merging guidance information including merging into the main lane immediately behind the preceding vehicle 3A, and the information related to the external appearance of the preceding vehicle 3A (OP205). For example, as the merging guidance information, a message: “Please merge to follow <vehicle 3A>” is transmitted to the vehicle 2A, and displayed on the display 217, or outputted from the speaker 216, of the vehicle 2A. In <vehicle 3A> in the message, for example, information indicating at least any one of a vehicle body color, a vehicle type, and a vehicle identification number of the vehicle 3A is included.

The road-side apparatus 1 transmits, to the following vehicle 3B to follow the vehicle 2A, merging assist guidance information including allowing the leading vehicle 2A to merge, and the information related to the external appearance of the vehicle 2A (FIG. 6, OP206). For example, as the merging assist guidance information, a message: “Please allow <vehicle 2A> to merge” is displayed on the display 217, or outputted from the speaker 216, of the vehicle 3B. In <vehicle 2A> in the message, for example, information indicating at least any one of a vehicle body color, a vehicle type, and a vehicle identification number of the vehicle 2A is included.

The road-side apparatus 1 identifies the vehicles 2B and 2C located in the waiting-for-merging area 5B (FIG. 6, OP208). The road-side apparatus 1 transmits waiting-for-merging guidance information to the vehicles 2B and 2C (FIG. 6, OP209). For example, as the waiting-for-merging guidance information, a message: “Please refrain from merging at the present position” is displayed on the display 217, or outputted from the speaker 216, of each of the vehicles 2B and 2C.

Note that as the merging guidance information, merging in front of the following vehicle and information related to an external appearance of the following vehicle may be notified. Specifically, as the merging guidance information notified to the vehicle 2A in FIG. 9, a message: “Please merge into the main lane in front of <vehicle 3B>” may be transmitted. Alternatively, as the merging guidance information, information related to both the preceding vehicle and the following vehicle may be notified. Specifically, as the merging guidance information notified to the vehicle 2A in FIG. 9, a message: “Please merge into the main lane between <vehicle 3A> and <vehicle 3B>” may be transmitted. In <vehicle 3A> and <vehicle 3B> in such messages, for example, information indicating at least any one of respective vehicle body colors, vehicle types, and vehicle identification numbers of the vehicle 3A and the vehicle 3B are included.

<Operation and Effects of the First Embodiment>

According to the first embodiment, smooth merging can be accomplished because guidance information about merging is transmitted to both a vehicle that merges into the main lane from the acceleration lane and a vehicle that travels on the main lane behind the merging vehicle. The road-side apparatus 1 transmits guidance information to each vehicle traveling in the vicinity of the merging point such that merging is performed according to the zipper method. Thus, it is possible to restrain congestion from occurring or worsening due to merging into the main lane from the acceleration lane.

A vehicle that merges into the main lane from the acceleration lane is notified of information related to an external appearance of a vehicle traveling on the main lane ahead of the merging vehicle, and the vehicle on the main lane is notified of information related to an external appearance of the vehicle that merges into the main lane from the acceleration lane. Thus, it is possible to assist a driver of each vehicle that has received the guidance information in identifying a vehicle behind which the own vehicle is to merge into the main lane, or a vehicle to be allowed to merge into the main lane in front of the own vehicle from the acceleration lane.

In the first embodiment, waiting-for-merging guidance information indicating to wait for merging into the main lane is transmitted to a vehicle located in the waiting-for-merging area. Thus, it is possible to restrain a vehicle on the acceleration lane that has not arrived in a vicinity of the far end of the acceleration lane from merging into the main lane.

In the first embodiment, the merging guidance processing as described above is performed when congestion occurs. Thus, it is possible to reduce operating time of the road-side apparatus 1 and the vehicles 2 for the merging guidance processing, and it is possible to reduce processing loads on and use of resources by the road-side apparatus 1 and the vehicles 2.

### Second Embodiment

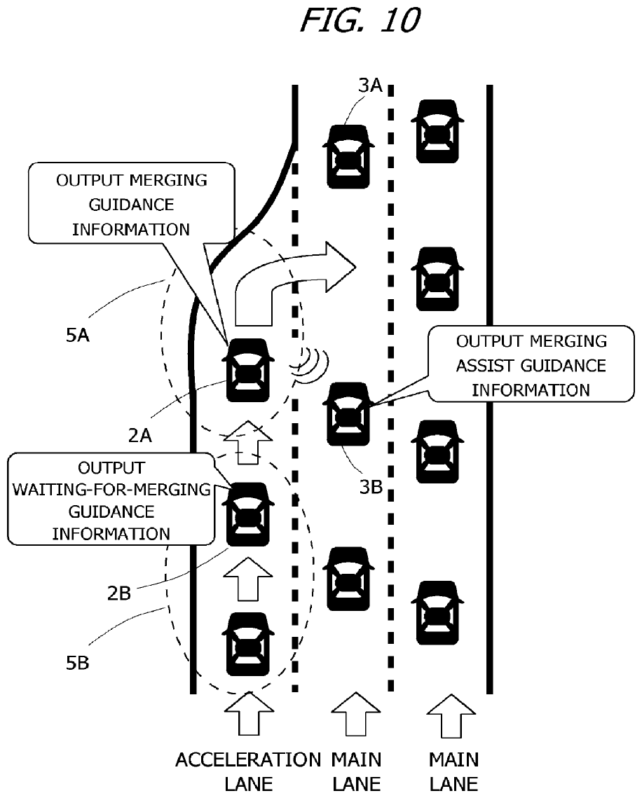

FIG. 10 illustrates an example of a system configuration of a merging guidance system according to a second embodiment. In the second embodiment, each vehicle autonomously performs merging guidance processing, without intervention of an apparatus in a third-party position such as the road-side apparatus 1. Note that in the second embodiment, a description common to the first embodiment is omitted.

In FIG. 10, each vehicle 2 is capable of vehicle-to-vehicle communication, and, when entering a predetermined range including a merging point, starts transmitting a merging point approach signal and exchanges vehicle information with each other. The merging point approach signal according to the second embodiment includes, for example, identification information on the vehicle 2, and information related to an external appearance of the vehicle 2.

Each vehicle 2 determines, from own position information, which of a merging area 5A, a waiting-for-merging area 5B, a predetermined range on a main lane adjacent to the merging area 5A and the waiting-for-merging area 5B, and any other area the vehicle 2 is located in, and generates and outputs guidance information according to the own position. For example, when a vehicle 2 determines that the vehicle 2 is located in the merging area 5A and at a front on the lane (in a case of a vehicle 2A in FIG. 10), the vehicle 2A outputs merging guidance information. For example, when a vehicle 2 determines that the vehicle 2 is located in the waiting-for-merging area 5B (in a case of a vehicle 2B in FIG. 10), the vehicle 2B outputs waiting-for-merging guidance information. For example, when a vehicle 2 is a vehicle traveling in the predetermined range on the main lane adjacent to the merging area 5A and the waiting-for-merging area 5B (in a case of a vehicle 3B in FIG. 10), the vehicle 3B outputs merging assist guidance information.

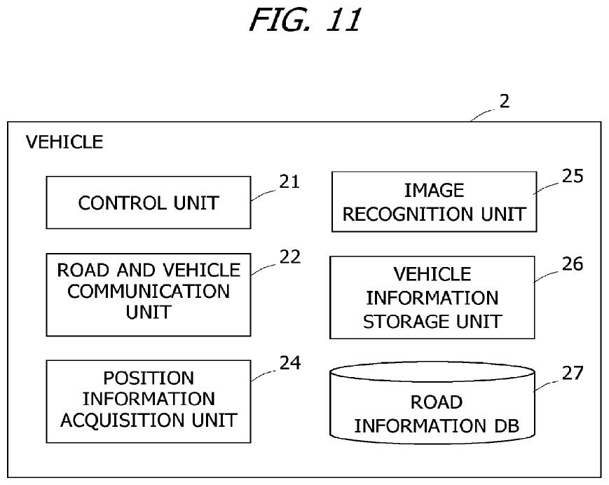

FIG. 11 illustrates an example of a functional configuration of a vehicle 2 according to the second embodiment. A hardware configuration of the vehicle 2 according to the second embodiment is similar to that of the first embodiment. In other words, a control apparatus 20 of the vehicle 2 according to the second embodiment is an example of the “information processing apparatus”. The vehicle 2 according to the second embodiment includes, as functional components, a control unit 21, a road and vehicle communication unit 22, a position information acquisition unit 24, an image recognition unit 25, a vehicle information storage unit 26, and a road information database (DB) 27.

The road and vehicle communication unit 22 in the second embodiment is an interface when communication is performed with another vehicle 2 through vehicle-to-vehicle communication by the V2X communication unit 205. The position information acquisition unit 24 acquires position information, for example, in each predetermined period from the GPS reception unit 211 and outputs the position information to the control unit 21.

The image recognition unit 25 performs, in each predetermined period, image recognition processing for detecting a vehicle from an image picked up by the camera 212. For example, the image recognition unit 25 receives vehicle information as input from the control unit 21 and, by using the vehicle information, performs image recognition on an image picked up by the camera 212. As a result of image recognition by the image recognition unit 25, for example, a detected vehicle, a positional relationship between the own vehicle and the detected vehicle, types of lanes on which the own vehicle and the other vehicle travel (an acceleration lane, the main lane, and the like), and the like are acquired. The image recognition unit 25 outputs the result of image recognition to the control unit 21.

The vehicle information storage unit 26 is created, for example, in the storage area of the memory 202 of the control apparatus 20 of the vehicle 2. The vehicle information storage unit 26 stores vehicle information received from another vehicle 2. The vehicle information stored in the vehicle information storage unit 26 is registered and deleted by the control unit 21.

The road information DB 27 is a database that retains information related to a road. The information related to a road includes position information on a merging point, and settings of a merging area and a waiting-for-merging area at each merging point. The information related to a road may also include position information on and a type of each lane at each point.

The control unit 21 controls merging guidance processing according to the second embodiment. The control unit 21 receives position information as input from the position information acquisition unit 24. The control unit 21 refers to the road information DB 27 and, when detecting from the position information that the vehicle 2 has entered a predetermined range from a merging point, starts issuing a merging point approach signal via the road and vehicle communication unit 22. The merging point approach signal is transmitted in a multicast or broadcast in each predetermined period. The merging point approach signal includes, for example, vehicle information on the vehicle 2. Moreover, when the control unit 21 detects that the vehicle 2 enters the predetermined range from the merging point, the control unit 21 instructs the image recognition unit 25 to start image recognition processing.

The issuance of a merging point approach signal and the image recognition processing are stopped, for example, when a predetermined condition for termination is satisfied. The condition for termination of the issuance of a merging point approach signal and the image recognition processing is, for example, any one or both of an exit out of the predetermined range from the merging point, and passage of a predetermined time period since the start. Note that a condition for termination of the issuance of a merging point approach signal and a condition for termination of the image recognition processing may be different from each other.

When a merging point approach signal issued from another vehicle 2 is received, the control unit 21 stores vehicle information included in the received merging point approach signal into the vehicle information storage unit 26. Such vehicle information is deleted from the vehicle information storage unit 26, or the vehicle information storage unit 26 is refreshed, when a predetermined condition for termination is satisfied. The condition for termination is, for example, any one or more of a fact that the vehicle 2 exits out of the predetermined range from the merging point, a fact that the predetermined time period has passed since the issuance of a merging point approach signal and the image recognition processing were started, a fact that a merging point approach signal is not received from any vehicle, and the like.

The control unit 21 refers to the road information DB 27 and, when detecting from the position information that the vehicle 2 is present in the merging area, determines whether or not the vehicle 2 is a leading vehicle on the acceleration lane. When the vehicle 2 is traveling at the front in the merging area, the control unit 21 outputs merging guidance information.

The determination of whether or not the vehicle 2 is a leading vehicle on the acceleration lane is performed, for example, by determining whether or not another vehicle located in front of the vehicle 2 is detected in a result of image recognition on an image picked up by the camera 212 installed toward a front outside of the vehicle 2. When the vehicle 2 is a leading vehicle on the acceleration lane, the control unit 21 identifies, among vehicles traveling on the main lane, a preceding vehicle and a following vehicle for the vehicle 2. For example, as the preceding vehicle, a closest vehicle that travels on the main lane ahead of the vehicle 2 is identified. For example, as the following vehicle, a closest vehicle that travels on the main lane behind the vehicle 2 is identified. Methods for identifying a preceding vehicle and for identifying a following vehicle are not limited to such methods.

The control unit 21 refers to the road information DB 27 and, when detecting from the position information that the vehicle 2 is present in the waiting-for-merging area, outputs waiting-for-merging guidance information.

The control unit 21 refers to the road information DB 27 and, when detecting from the position information that the vehicle 2 is present on the main lane, determines whether or not a vehicle on the acceleration lane is detected from the result of image recognition. When a vehicle on the acceleration lane is detected from the result of image recognition, the control unit 21 outputs merging assist guidance information. Note that the merging assist guidance information in the present case may, for example, simply indicate to allow the vehicle on the acceleration lane to merge into the main lane, without including information on any particular vehicle.

When the vehicle 2 is a leading vehicle in the merging area, the control unit 21 transmits a merging request to the following vehicle. The merging request is a request to cut into the main lane for merging. The merging request includes, for example, vehicle information on a source vehicle. When a merging request is received, the control unit 21 outputs merging assist guidance information. The merging assist guidance information includes vehicle information received along with the merging request. Transmitting a merging request to another vehicle 2 is an example of “notifying the second vehicle of second guidance”.

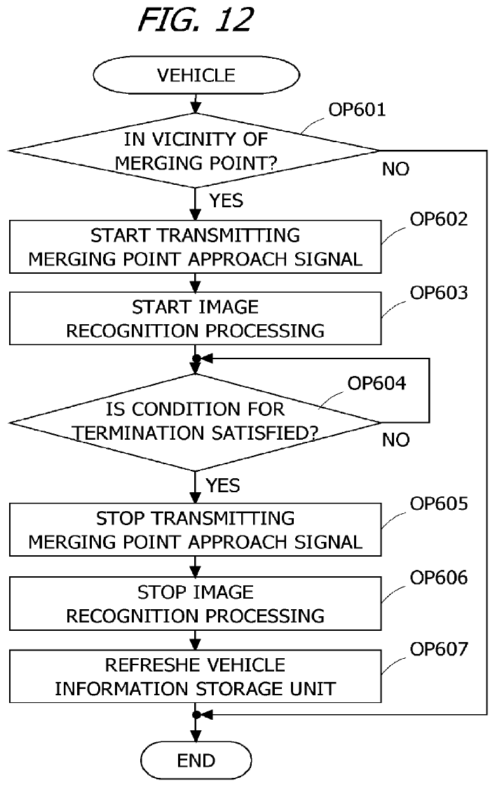

FIG. 12 is an example of processing when a vehicle 2 passes through a merging point according to the second embodiment. For example, the processing illustrated in FIG. 12 is performed repeatedly while occurrence of congestion is detected in a section on a traveled road. However, the processing illustrated in FIG. 12 is performed not just at such a timing, but may be performed repeatedly, irrespective of the presence or absence of congestion.

In OP601, the control unit 21 refers to the road information DB 27, and determines based on the position information whether or not the vehicle 2 is in a vicinity of a merging point. For example, when the vehicle 2 is within a predetermined range from the merging point, positive determination is made in OP601. When it is detected that the vehicle 2 enters the vicinity of the merging point (OP601: YES), the processing advances to OP602. When the vehicle 2 does not travel in the vicinity of the merging point (OP601: NO), the processing illustrated in FIG. 12 is terminated.

In OP602, the control unit 21 starts periodical transmission of a merging point approach signal. In OP603, the control unit 21 instructs the image recognition unit 25 to start image recognition processing.

In OP604, the control unit 21 determines whether or not the condition for termination of the transmission of a merging point approach signal and the image recognition processing is satisfied. When the condition for termination of the transmission of a merging point approach signal and the image recognition processing is satisfied (OP604: YES), the processing advances to OP605. When the condition for termination of the transmission of a merging point approach signal and the image recognition processing is not satisfied (OP604: NO), the processing in OP604 is performed repeatedly until the condition for termination is satisfied.

In OP605, the control unit 21 stops transmitting a merging point approach signal. In OP606, the control unit 21 instructs the image recognition unit 25 to stop the image recognition processing. In OP607, the control unit 21 refreshes the vehicle information storage unit 26. Thereafter, the processing illustrated in FIG. 12 is terminated.

Note that although FIG. 12 illustrates an example in a case where the condition for termination of the transmission of a merging point approach signal and the image recognition processing is the same as a condition for refreshing the vehicle information storage unit 26, such an example does not constitute a limitation.

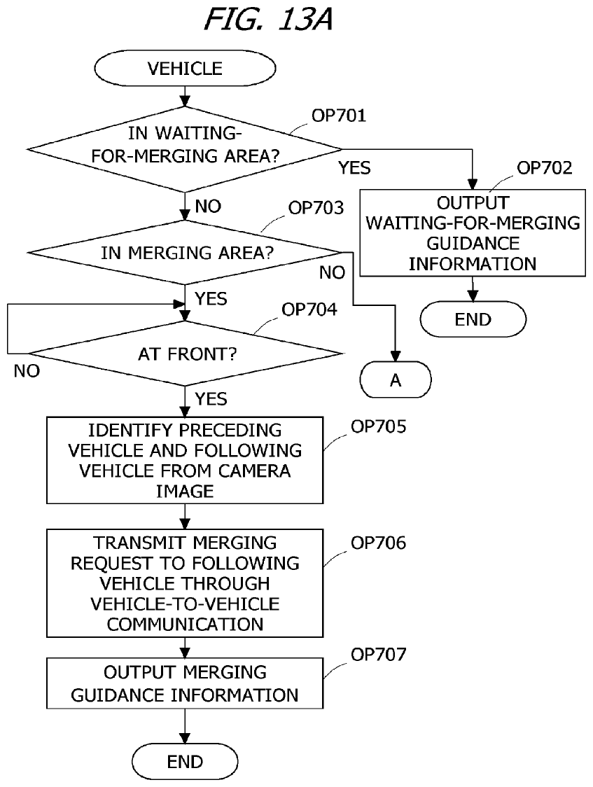

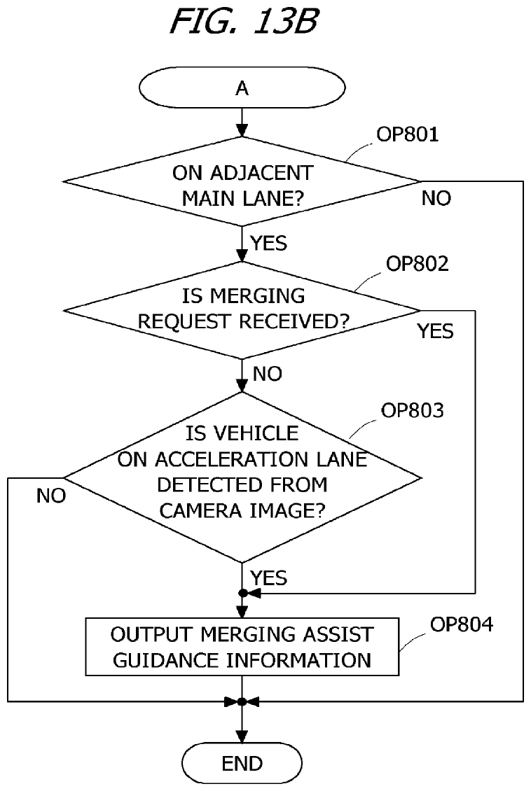

FIGS. 13A and 13B are an example of a flowchart of merging guidance processing by the vehicle 2 according to the second embodiment. For example, the processing illustrated in FIGS. 13A and 13B is performed repeatedly while occurrence of congestion is detected in a section on a traveled road.

In OP701, the control unit 21 determines whether or not the vehicle 2 is located in the waiting-for-merging area. When the vehicle 2 is located in the waiting-for-merging area (OP701: YES), the processing advances to OP702. In OP702, the control unit 21 outputs waiting-for-merging guidance information. Thereafter, the processing illustrated in FIG. 13A is terminated.

When the vehicle 2 is not located in the waiting-for-merging area (OP701: NO), the processing advances to OP703. In OP703, the control unit 21 determines whether or not the vehicle 2 is located in the merging area. When the vehicle 2 is located in the merging area (OP703: YES), the processing advances to OP704. When the vehicle 2 is not located in the merging area (OP703: NO), the processing advances to OP801 in FIG. 13B.

In OP704, the control unit 21 determines whether or not the vehicle 2 is a leading vehicle. When the vehicle 2 is a leading vehicle (OP704: YES), the processing advances to OP705. When the vehicle 2 is not a leading vehicle (OP704: NO), the processing in OP704 is repeated until the vehicle 2 becomes a leading vehicle.

In OP705, the control unit 21 identifies, from a result of image recognition on an image picked up by the camera 212, a preceding vehicle and a following vehicle for the vehicle 2 on the main lane. In OP706, the control unit 21 transmits a merging request to the following vehicle through vehicle-to-vehicle communication. In OP707, the control unit 21 outputs merging guidance information. The merging guidance information includes information related to an external appearance of the preceding vehicle identified in OP705. The information related to the external appearance of the preceding vehicle is acquired by receiving a merging point approach signal issued from the preceding vehicle. Thereafter, the processing illustrated in FIG. 13A is terminated.

The processing illustrated in FIG. 13B is processing when the vehicle 2 is not located in the waiting-for-merging area or the merging area. In OP801, the control unit 21 determines whether or not the vehicle 2 is located on the main lane adjacent to the merging area and the waiting-for-merging area. When the vehicle 2 is located on the main lane adjacent to the merging area and the waiting-for-merging area (OP801: YES), the processing advances to OP802. When the vehicle 2 is not located on the main lane adjacent to the merging area and the waiting-for-merging area (OP801: NO), the processing illustrated in FIG. 13B is terminated.

In OP802, the control unit 21 determines whether or not a merging request is received from another vehicle 2. When a merging request is received from another vehicle 2 (OP802: YES), the processing advances to OP804. When a merging request is not received from another vehicle 2 (OP802: NO), the processing advances to OP803.

In OP803, the control unit 21 determines whether or not a vehicle on the acceleration lane is detected from a result of image recognition on an image picked up by the camera 212. When a vehicle on the acceleration lane is detected from the result of image recognition on the image picked up by the camera 212 (OP803: YES), the processing advances to OP804. When a vehicle on the acceleration lane is not detected from the result of image recognition on the image picked up by the camera 212 (OP803: NO), the processing illustrated in FIG. 13B is terminated.

In OP804, the control unit 21 outputs merging assist guidance information. Note that when a merging request is received, the merging assist guidance information includes vehicle information on a source vehicle. The merging assist guidance information does not need to include vehicle information on a particular vehicle when a vehicle on the acceleration lane is detected from the result of image recognition on the image picked up by the camera 212. Thereafter, the processing illustrated in FIG. 13B is terminated.

According to the second embodiment, when vehicles 2 are capable of vehicle-to-vehicle communication and can exchange own information with each other, the vehicles 2 themselves can perform merging guidance.

### Third Embodiment

In a third embodiment, a vehicle 2 that does not include a vehicle-to-vehicle communication function performs merging guidance alone. In the third embodiment, a description common to the first embodiment and the second embodiment is also omitted.

A hardware configuration of a vehicle 2 according to the third embodiment is similar to the vehicle 2 according to the first embodiment, except that the vehicle 2 according to the third embodiment does not include the V2X communication unit. A functional configuration of the vehicle 2 according to the third embodiment is similar to the functional configuration of the vehicle 2 according to the second embodiment illustrated in FIG. 11, except that the vehicle 2 according to the third embodiment does not include the vehicle information storage unit 26.

In the third embodiment, the vehicle 2 is not capable of vehicle-to-vehicle communication, and is therefore unable to acquire vehicle information on another vehicle 2 from the another vehicle 2. Accordingly, the vehicle 2 acquires vehicle information on another vehicle 2 through image recognition processing on an image picked up by the camera 212. A merging request is not made to another vehicle 2 through vehicle-to-vehicle communication either. In such two points, processing by the vehicle 2 according to the third embodiment is different from the second embodiment.

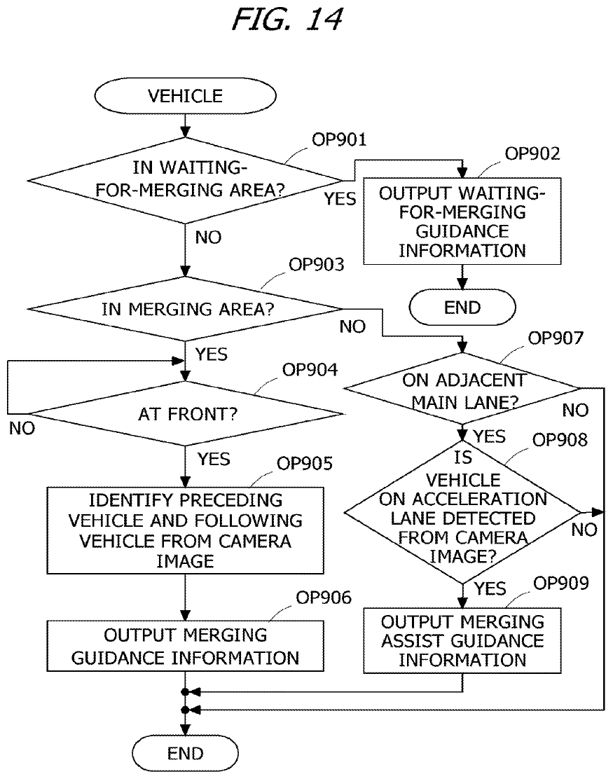

FIG. 14 is an example of a flowchart of merging guidance processing by the vehicle 2 according to the third embodiment. For example, the processing illustrated in FIG. 14 is performed repeatedly while occurrence of congestion is detected in a section on a traveled road. However, the processing illustrated in FIG. 14 is performed not just at such a time, but may be performed repeatedly, irrespective of presence or absence of congestion.

In OP901, the control unit 21 determines whether or not the vehicle 2 is located in the waiting-for-merging area. When the vehicle 2 is located in the waiting-for-merging area (OP901: YES), the processing advances to OP902. In OP902, the control unit 21 outputs waiting-for-merging guidance information. Thereafter, the processing illustrated in FIG. 14 is terminated.

When the vehicle 2 is not located in the waiting-for-merging area (OP901: NO), the processing advances to OP903. In OP903, the control unit 21 determines whether or not the vehicle 2 is located in the merging area. When the vehicle 2 is located in the merging area (OP903: YES), the processing advances to OP904. When the vehicle 2 is not located in the waiting-for-merging area or the merging area (OP903: NO), the processing advances to OP907.

In OP904, the control unit 21 determines whether or not the vehicle 2 is a leading vehicle. When the vehicle 2 is a leading vehicle (OP904: YES), the processing advances to OP905. When the vehicle 2 is not a leading vehicle (OP904: NO), the processing in OP904 is repeated until the vehicle 2 becomes a leading vehicle.

In OP905, the control unit 21 identifies, from a result of image recognition on an image picked up by the camera 212, a preceding vehicle and a following vehicle for the vehicle 2 on the main lane. In OP906, the control unit 21 outputs merging guidance information. The merging guidance information includes information related to an external appearance of the preceding vehicle identified in OP905. The information related to the external appearance of the preceding vehicle is acquired through the image recognition processing in OP905. Thereafter, the processing illustrated in FIG. 14 is terminated.

Processing from OP907 to OP909 is processing when the vehicle 2 is not located in the waiting-for-merging area or the merging area. In OP907, the control unit 21 determines whether or not the vehicle 2 is located on the main lane adjacent to the merging area and the waiting-for-merging area. When the vehicle 2 is located on the main lane adjacent to the merging area and the waiting-for-merging area (OP907: YES), the processing advances to OP908. When the vehicle 2 is not located on the main lane adjacent to the merging area and the waiting-for-merging area (OP907: NO), the processing illustrated in FIG. 14 is terminated.

In OP908, the control unit 21 determines whether or not a vehicle on the acceleration lane is detected from a result of image recognition on an image picked up by the camera 212. When a vehicle on the acceleration lane is detected from the result of image recognition on the image picked up by the camera 212 (OP908: YES), the processing advances to OP909. When a vehicle on the acceleration lane is not detected from the result of image recognition on the image picked up by the camera 212 (OP908: NO), the processing illustrated in FIG. 14 is terminated.

In OP909, the control unit 21 outputs merging assist guidance information. Since vehicle information is not able to be received from the vehicle on the acceleration lane detected from the result of image recognition on the image picked up by the camera 212, the merging assist guidance information does not need to include vehicle information on a particular vehicle. Alternatively, the merging assist guidance information may include information related to an external appearance of a vehicle, such as a vehicle type and a vehicle body color that is acquired from the image picked up by the camera 212. Thereafter, the processing illustrated in FIG. 14 is terminated.

According to the third embodiment, even if a vehicle 2 is not capable of vehicle-to-vehicle communication, the vehicle 2 itself can perform merging guidance.

### Other Embodiments

The embodiment described above is an example, and the present disclosure may be changed and carried out as appropriate without departing from the gist of the present disclosure.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus, comprising a controller configured to:
identify a second vehicle traveling on a main lane behind a cutting-in position at which a first vehicle traveling on an acceleration lane cuts in; and
perform at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.

2. The information processing apparatus according to claim 1, wherein the controller is configured to:
further perform identifying a third vehicle traveling on the main lane ahead of the cutting-in position; and
notify the first vehicle, as the first guidance, to merge into the main lane immediately behind the third vehicle, and of information related to an external appearance of the third vehicle.

3. The information processing apparatus according to claim 1, wherein the controller is configured to notify the first vehicle, as the first guidance, to merge into the main lane in front of the second vehicle, and of information related to an external appearance of the second vehicle.

4. The information processing apparatus according to claim 1, wherein the controller is configured to notify the second vehicle, as the second guidance, to allow the first vehicle to merge into the main lane in front of the second vehicle, and of information related to an external appearance of the first vehicle.

5. The information processing apparatus according to claim 1, wherein the controller is configured to notify the first guidance when it is detected that the first vehicle enters a merging area including the far end of the acceleration lane.

6. The information processing apparatus according to claim 1, wherein the controller is configured to notify the first guidance when the first vehicle travels at a front on the acceleration lane.

7. The information processing apparatus according to claim 5, wherein the controller is configured to further perform notifying the first vehicle of third guidance that indicates to wait for merging into the main lane when the first vehicle travels on the acceleration lane short of the merging area.

8. The information processing apparatus according to claim 1, wherein the controller is configured to perform the identification of the second vehicle and at least any one of the notification of the first guidance and the notification of the second guidance when it is detected that a road in a predetermined section including the main lane is congested.

9. The information processing apparatus according to claim 1, wherein the information processing apparatus is a road-side apparatus installed in a vicinity of the acceleration lane and the main lane, and
the controller is configured to:
identify the first vehicle and the second vehicle, from an image picked up by an image-pickup apparatus that has an image-pickup range including a vicinity of the far end of the acceleration lane; and
transmit the first guidance to the first vehicle and the second guidance to the second vehicle through road-to-vehicle communication.

10. The information processing apparatus according to claim 9, wherein the controller is configured to:
receive information related to a vehicle external appearance of each of the first vehicle and the second vehicle through road-to-vehicle communication; and
retain the information related to the vehicle external appearance while the first vehicle and the second vehicle are detected from an image picked up by the image-pickup apparatus.

11. The information processing apparatus according to claim 1, wherein the information processing apparatus is an in-vehicle apparatus, and
the controller is configured to:
further perform detecting, from position information, that a vehicle in which the in-vehicle apparatus is mounted corresponds to the first vehicle; and
when the vehicle in which the in-vehicle apparatus is mounted corresponds to the first vehicle, as the notification of the first guidance to the first vehicle, output image data or audio data from at least one of a display device and a speaker included in the vehicle in which the in-vehicle apparatus is mounted, and as the notification of the second guidance to the second vehicle, transmit the second guidance to the second vehicle through vehicle-to-vehicle communication.

12. An information processing method, comprising:
identifying a second vehicle traveling on a main lane behind a cutting-in position at which a first vehicle traveling on an acceleration lane cuts in; and
performing at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.

13. The information processing method according to claim 12, further comprising identifying a third vehicle traveling on the main lane ahead of the cutting-in position,
wherein the method includes notifying the first vehicle, as the first guidance, to merge into the main lane immediately behind the third vehicle, and of information related to an external appearance of the third vehicle.

14. The information processing method according to claim 12, wherein the method includes notifying the first vehicle, as the first guidance, to merge into the main lane in front of the second vehicle, and of information related to an external appearance of the second vehicle.

15. The information processing method according to claim 12, wherein the method includes notifying the second vehicle, as the second guidance, to allow the first vehicle to merge into the main lane in front of the second vehicle, and of information related to an external appearance of the first vehicle.

16. The information processing method according to claim 12, wherein the method includes notifying the first guidance when it is detected that the first vehicle enters a merging area including the far end of the acceleration lane.

17. The information processing method according to claim 12, wherein the method includes notifying the first guidance when the first vehicle travels at a front on the acceleration lane.

18. The information processing method according to claim 16, the method further includes notifying the first vehicle of third guidance that indicates to wait for merging into the main lane when the first vehicle travels on the acceleration lane short of the merging area.

19. The information processing method according to claim 12, wherein the method includes performing the identification of the second vehicle and at least any one of the notification of the first guidance and the notification of the second guidance when it is detected that a road in a predetermined section including the main lane is congested.

20. A non-transitory computer-readable recording medium stored with a program causing a computer to execute:
identifying a second vehicle traveling on a main lane behind a cutting-in position at which a first vehicle traveling on an acceleration lane cuts in; and
at least any one of notifying the first vehicle of first guidance that prompts the first vehicle to merge into the main lane at a far end of the acceleration lane, and notifying the second vehicle of second guidance that prompts the second vehicle to assist the first vehicle in merging into the main lane.
